(19) United States
(12) Patent Application Publication
(10) Pub. No.: US 2009/0113101 A1
(43) Pub. Date: Apr. 30, 2009

(54) ADAPTER FOR USB INTERFACE

(75) Inventors: Chang-Chun Liu, Shenzhen (CN); Xiao-Lin Gan, Shenzhen (CN); Yu-Kuang Ho, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (TW); HON HAI PRECISION INDUSTRY CO., LTD., Tu-Cheng (TW)

(21) Appl. No.: 11/957,499

(22) Filed: Dec. 17, 2007

(30) Foreign Application Priority Data
Oct. 26, 2007 (CN) 200710202284.2

(51) Int. Cl. G06F 13/00

(52) U.S. Cl. 710/300

(57) ABSTRACT

An adapter for USB interfaces, includes a cable, and two interface units respectively electrically connected to ends of the cable. Each of the interfaces includes a main body and two different types of USB interfaces extending from the main body.

### BACKGROUND

1. Field of the Invention

The present invention relates to adapters for universal serial bus (USB) interfaces.

2. Description of related art

Nowadays, different types of USB interface devices, such as standard USB interfaces and mini-USB interfaces are used in many fields. Thereby, some USB adapters are designed to adapt two devices having different types of USB interfaces.

Referring to FIGS. 1A to 1C, there are usually three kinds of USB adapters 10, 20 and 30. The adapter 10 has two standard USB interfaces respectively connected to ends of a cable. The adapter 20 has two mini-USB interfaces respectively connected to ends of a cable. The adapter 30 has a standard USB interface and a mini-USB interface respectively connected to ends of a cable. However, it is a disadvantage that the USB adapters 10, 20 or 30 can only be used between two devices with USB interfaces corresponding to one of these three combinations.

What is needed is to provide an adapter which can accommodate devices with different types of USB interfaces.

### SUMMARY

An embodiment of an adapter for USB interfaces, includes a cable, and two interface units respectively electrically connected to ends of the cable. Each of the interfaces includes a main body and two different types of USB interfaces extending from the main body.

Other advantages and novel features of the present invention will become more apparent from the following detailed description of an embodiment when taken in conjunction with the accompanying drawings, in which:

### BRIEF DESCRIPTION OF THE DRAWING

FIGS. 1A to 1C are top plan views of typical USB adapters in related art;

FIG. 2 is a top plan view of an adapter in accordance with an embodiment of the present invention; and

FIG. 3 is a circuit diagram of the adapter of FIG. 2.

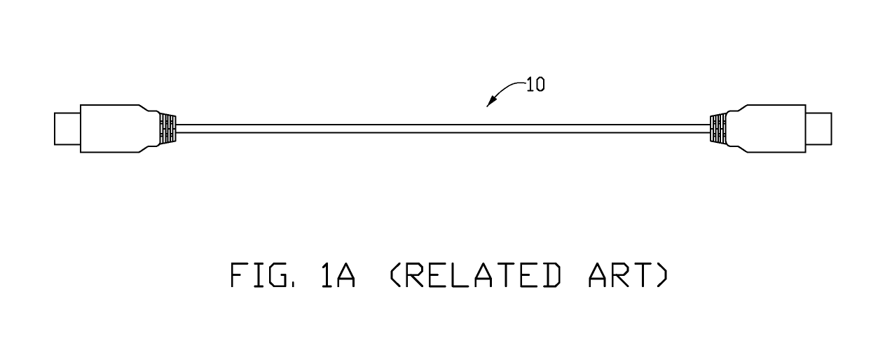

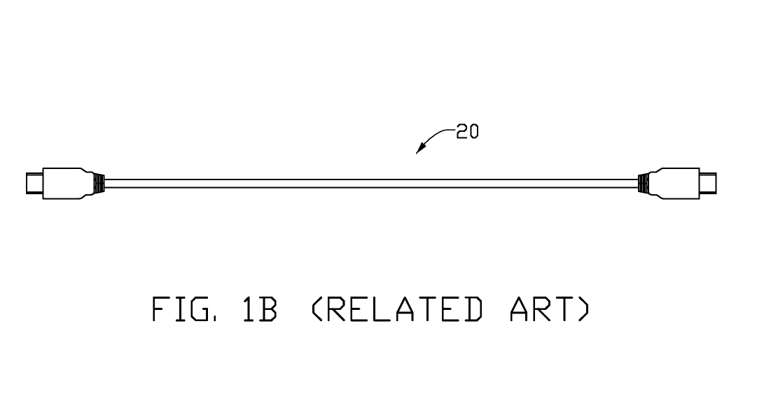

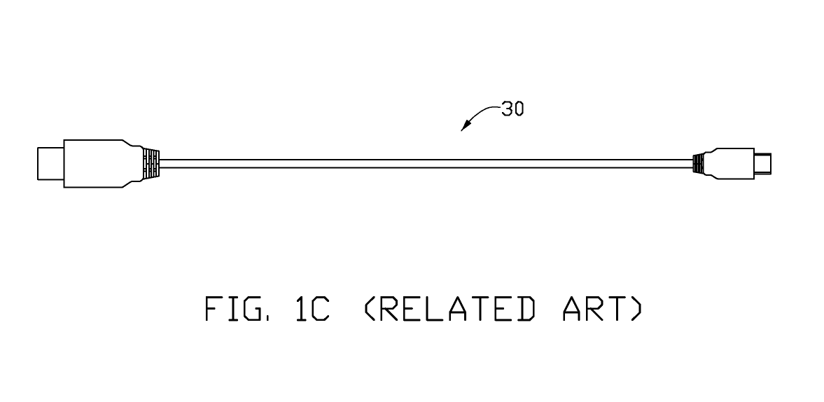

### DETAILED DESCRIPTION

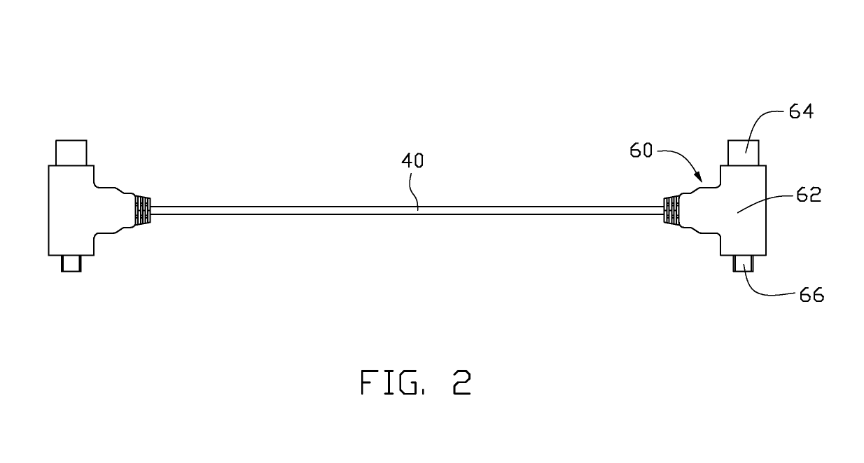

Referring to FIG. 2, an adapter in accordance with an embodiment of the present invention includes a cable 40 and two interface units 60 respectively connected to ends of the cable 40.

Each interface unit 60 includes a T-shaped main body 62, a standard USB interface 64, and a mini-USB interface 66. The standard USB interface 64 and the mini-USB interface 66 respectively extend from opposite ends of the T-shaped main body 62, and a third end of the T-shaped main body 62 is connected to the corresponding end of the cable 40.

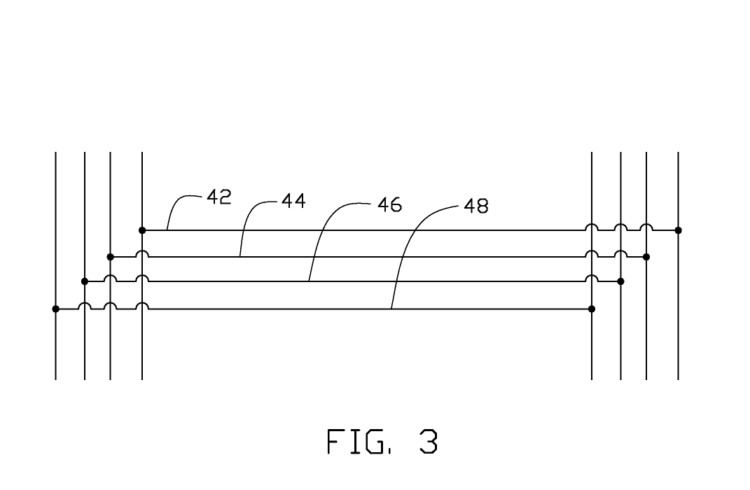

Referring also to FIG. 3, a ground wire 42, a first data wire 44, a second data wire 46, and a power wire 48 are set in the cable 40. Each end of each of the wires 42, 44, 46 and 48 is separated into two branch lines for extending into the corresponding standard USB interface 64 and the corresponding mini-USB interface 66, and are configured for transmitting electrical signals.

Because each interface unit 60 of the adapter includes two different types of USB interface, three combinations of electronic devices, i.e. two electronic devices both having standard USB interfaces, two electronic devices both having mini-USB interfaces, and two electronic devices respectively having standard USB interface and mini-USB interface, can be accommodated by the adapter.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adapter for universal serial bus (USB) interfaces, comprising:
a cable; and
two interface units respectively electrically connected to ends of the cable, each of the interfaces comprising a main body and two different types of USB interfaces extending from the main body.

2. The adapter as claimed in claim 1, wherein the two different types of USB interfaces are a standard USB interface and a mini-USB interface.

3. The adapter as claimed in claim 1, wherein said two different types of USB interfaces are oppositely set on the main body.

4. The adapter as claimed in claim 3, wherein the main body is T-shaped, said two different types of USB interfaces respectively extend from opposite ends of the T-shaped main body.

5. The adapter as claimed in claim 4, wherein a third end of the T-shaped main body is connected to the corresponding end of the cable.

6. The adapter as claimed in claim 1, wherein a ground wire, a first data wire, a second data wire, and a power wire are set in the cable, each end of each of the wires is separated into two branch lines for extending into the corresponding USB interfaces of one of the interface units for transmitting electrical signals.
